(19) United States
(12) Patent Application Publication
(10) Pub. No.: US 2006/0018385 A1
(43) Pub. Date: Jan. 26, 2006

(54) Method and apparatus for intra prediction of video data

(75) Inventor: Nam-suk Lee, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/108,849

(22) Filed: Apr. 19, 2005

(30) Foreign Application Priority Data
Jul. 21, 2004 (KR) 10-2004-0056817

(51) Int. Cl. H04N 11/04; H04N 11/02; H04N 7/12; H04B 1/66

(52) U.S. Cl. 375/240.24; 375/240.01

(57) ABSTRACT

A method and apparatus are used for intra prediction of video data. The method includes performing intra prediction on a current macroblock in a plurality of K×L intra prediction modes using original pixel values of a plurality of previous macroblocks that are adjacent to the current macroblock. The K×L intra prediction mode having a relatively low intra prediction error among the plurality of K×L intra prediction modes is determined, Intra prediction is performed on the current macroblock in a plurality of M×N intra prediction modes using the original pixel values of the plurality of previous macroblocks. The M×N intra prediction mode having a relatively low intra prediction error among the plurality of M×N intra prediction modes is determined. One of the determined K×L intra prediction mode and the determined M×N intra prediction mode which has the smaller intra prediction error is used as an optimum intra prediction mode for the current macroblock.

### CROSS-REFERENCE TO RELATED APPLICATION

This application claims the benefit of Korean Patent Application No. 10-2004-0056817, filed on Jul. 21, 2004, in the Korean Intellectual Property Office, the disclosure of which is incorporated by reference.

### BACKGROUND OF THE INVENTION

1. Field of the Invention

The present invention relates to a method and apparatus for intra prediction of video data, and more particularly, to a method and apparatus for intra prediction of video data, in which intra prediction of video data can be performed simply and rapidly.

2. Description of the Related Art

Since video contains a large amount of data, compression encoding is essential for storage or transmission of video data. Encoding or decoding of video data is performed in data units such as macroblocks of 16×16 pixels or blocks of 4×4 pixels.

New video compression encoding standards called MPEG-4 Part 10 advanced video coding (AVC) or ITU-T H.264 have been established. In particular, H.264 has been developed to cope with a change from a conventional circuit switching service to a packet switching service, various communication infrastructures, and the rapid spread of new communication channels such as mobile networks.

H.264 improves encoding efficiency by 50% or more in comparison to existing standards such as the MPEG-4 Part 2 visual codec and considers error robustness and network friendliness to cope with the rapidly changing wireless environment and Internet environment.

Intra prediction is a technique for compressing video data using spatial correlation of video. More specifically, after pixel values of a current data unit are predicted using pixel values of at least one previous data unit corresponding to the current data unit, a difference between actual pixel values of the current data unit and the predicted pixel values is entropy coded and then transmitted. Therefore, by performing intra predictive encoding, the efficiency of data compression is improved when the actual pixel values are entropy coded and then transmitted.

FIG. 1 shows previous data units used in a conventional intra prediction method for predicting a current data unit. Referring to FIG. 1, for intra prediction of a current data unit E, previous data units A, B, C, and D are used. According to a conventional raster scan scheme, data units included in an image are scanned left-to-right and top-to-bottom. Thus, according to a conventional raster scan scheme, the previous data units A, B, C, and D are already scanned and encoded before the current data unit E. Since data units marked with X are not encoded, they cannot be used for predictive encoding of the current data unit E. Since data units marked with O have low spatial correlation with the current data unit E, they are not used for predictive encoding of the current data unit E. After the previous data units are discrete cosine transformed (DCT) and quantized, they are inversely quantized and inversely DCTed and are then reconstructed.

According to H.264 standards, intra prediction includes 4×4 intra prediction and 16×16 intra prediction. In 4×4 intra prediction, prediction is performed in 4×4 subblock units. In 16×16 intra prediction, prediction is performed in 16×16 macroblock units.

4×4 intra prediction is divided into 9 modes, and 16×16 intra prediction is divided into 4 modes. Table 1 shows the 9 modes of H.264 4×4 intra prediction.

TABLE 1

| 4 × 4 Intra | |
|---|---|
| Prediction | |
| Mode No. | Name of 4 × 4 Intra Prediction Mode |
| 0 | Intra_4 × 4_Vertical prediction mode |
| 1 | Intra_4 × 4_Horizontal prediction mode |
| 2 | Intra_4 × 4_DC prediction mode |
| 3 | Intra_4 × 4_Diagonal_Down_Left prediction |
| | mode |
| 4 | Intra_4 × 4_Diagonal_Down_Right prediction |
| | mode |
| 5 | Intra_4 × 4_Vertical_Right prediction mode |
| 6 | Intra_4 × 4_Horizontal_Down prediction mode |
| 7 | Intra_4 × 4_Vertical_Left prediction mode |
| 8 | Intra_4 × 4_Horizontal_Up prediction mode |

Table 2 shows the 4 modes of H.264 16×16 intra prediction.

TABLE 2

| Intra 16 × 16 | |
|---|---|
| Prediction | |
| Mode No. | Name of 16 × 16 Intra Prediction Mode |
| 0 | Intra_16 × 16_Vertical prediction mode |
| 1 | Intra_16 × 16_Horizontal prediction mode |
| 2 | Intra_16 × 16_DC prediction mode |
| 3 | Intra_16 × 16_Plane prediction mode |

Intra prediction in H.264 will be described in greater detail with an example of 16×16 intra prediction. Referring back to FIG. 1, when the data unit E is a current data unit to be coded, the previous data units A and B are used as reference data units for 16×16 intra prediction. Also, not all of the pixel values of the previous data units A and B are used for predictive encoding, but, as shown in FIG. 2, 16 pixel values V0 through V15 of pixels included in the right-most line of the previous data unit A and 16 pixel values H0 through H15 of pixels included in the bottom-most line of the previous data unit B are used for predictive encoding.

FIGS. 3A through 3D show the 4 modes of 16×16 intra prediction according to H.264. FIG. 3A shows mode #0, which is called a vertical mode. When each actual pixel value of the current data unit E is P[x,y] where x=0 . . . 15, and y=0 . . . 15 and each predicted pixel value of the current data unit E is P′[x,y] where x=0 . . . 15, and y=0 . . . 15, the predicted pixel value P′[x,y] is determined using pixel values H0 through H15 of pixels included in the bottom-most line of the previous data unit B. In other words, as shown in FIG. 3A, P′[x, y] where x=0 . . . 15 and y=0 . . . 15, which is included in a vertical line, is one of pixel values H0 through H15. For example, predicted pixel values included in the first vertical line of the current data unit may all be H0 and predicted pixel values included in the second vertical line of the current data unit are all be H1.

FIG. 3B shows mode #1, which is called a horizontal mode. As shown in FIG. 3B, P′[x, y] where x=0 . . . 15 and y=0 . . . 15, which is included in a horizontal line, is one of pixel values V0 through V15. For example, predicted pixel values included in the first horizontal line of the current data unit may all be V0 and predicted pixel values included in the second horizontal line of the current data unit may all be V1.

FIG. 3C shows mode #2 called a DC mode. As shown in FIG. 3C, P′[x, y] where x=0 . . . 15 and y=0 . . . 15 is a mean value of H0 through H15 and V0 through V15. If the previous data unit A exists, but the previous data unit B does not exist, P[x, y] where x=0 . . . 15 and y=0 . . . 15 is a mean value of V0 through V15. If the previous data unit A does not exist, but the previous data unit B exists, P′[x, y] where x=0 . . . 15 and y=0 . . . 15 is a mean value of H0 through H15. If neither the previous data unit A nor the previous data unit B exists, P′[x, y] where x=0 . . . 15 and y=0 . . . 15 is set to a predetermined value like 128.

FIG. 3D shows mode #3, which is called a plane mode. Referring to FIG. 3D, P′[x,y] where x=0 . . . 15 and y=0 . . . 15 is determined in which predicted pixel values located on the left side of the diagonal line are determined using V0 through V15 and predicted pixel values located on the right side of the diagonal line are determined using H0 through H15. Mode #3 is useful for spatial prediction of video that gradually changes.

In the case of 4×4 intra prediction, the current data unit E is divided into sixteen 4×4 subblocks and prediction is performed in 4×4 subblock units in the 9 modes.

Video encoders that comply with H.264 standards predictive-encode a current macroblock in the nine 4×4 intra prediction modes and the four 16×16 intra prediction modes and then determine a prediction mode having the smallest cost function value as an optimum intra prediction mode for the current macroblock. The cost function indicates the accuracy of predictive encoding and the amount of generated bit. Cost functions that can be used for intra prediction encoding include a sum of absolute difference (SAD) cost function, a sum of absolute transformed difference (SATD) cost function, a sum of square difference (SSD) cost function, a mean of absolute difference (MAD) cost function, and a Lagrange cost function.

As described above, H.264 offers numerous intra prediction modes that can improve data compression efficiency. However, encoders or decoders should be able to perform prediction in 13 different prediction modes to obtain intra-predicted values of a current macroblock, resulting in high system complexity. Also, pixel values of previous macroblocks that are used in intra prediction of a current macroblock are reconstructed through DCT, quantization, inverse quantization, and inverse DCT. Therefore, to perform intra prediction of the current macroblock, reconstructed values of pixels that are adjacent to the current macroblock should be obtained. As a result, much time is required for intra prediction.

### SUMMARY OF THE INVENTION

Additional aspects and/or advantages of the invention will be set forth in part in the description which follows and, in part, will be apparent from the description, or may be learned by practice of the invention.

The present invention provides a method for intra prediction of video data, in which intra prediction is performed simply and rapidly.

The present invention also provides an apparatus for intra prediction of video data, in which intra prediction is performed simply and rapidly.

The present invention also provides a computer-readable recording medium having embodied thereon a program for a method for intra prediction of video data, in which intra prediction is performed simply and rapidly.

According to one aspect of the present invention, there is provided a method for intra prediction of video data. The method includes performing intra prediction on a current macroblock in a plurality of 16×16 intra prediction modes using original pixel values of a plurality of previous macroblocks that are adjacent to the current macroblock and determining one 16×16 intra prediction mode having the smallest intra prediction error or a relatively lower intra prediction error among the plurality of 16×16 intra prediction modes, performing intra prediction on the current macroblock in a plurality of 4×4 intra prediction modes using the original pixel values of the plurality of previous macroblocks and determining one 4×4 intra prediction mode having the smallest intra prediction error or a relatively low intra prediction error among the plurality of 4×4 intra prediction modes, and determining which one of the determined 16×16 intra prediction mode and the determined 4×4 intra prediction mode has the smaller intra prediction error and using the intra prediction mode having the smaller area as an optimum intra prediction mode for the current macroblock.

According to another aspect of the present invention, there is provided an apparatus for intra prediction of video data. The apparatus includes a first intra prediction unit, a second intra prediction unit, and an intra prediction mode determining unit. The first intra prediction unit performs intra prediction on a current macroblock in a plurality of 16×16 intra prediction modes using original pixel values of a plurality of previous macroblocks that are adjacent to the current macroblock and determines one 16×16 intra prediction mode having the smallest intra prediction error among the plurality of 16×16 intra prediction modes. The second intra prediction unit performs intra prediction on the current macroblock in a plurality of 4×4 intra prediction modes using the original pixel values of the plurality of previous macroblocks and determines one 4×4 intra prediction mode having the smallest intra prediction error or relatively low intra prediction error among the plurality of 4×4 intra prediction modes. The intra prediction mode determining unit determines which one of the determined 16×16 intra prediction mode and the determined 4×4 intra prediction mode has the smaller intra prediction error and uses the intra prediction mode having the smaller area as an optimum intra prediction mode for the current macroblock.

According to yet another aspect of the present invention, there is provided a computer-readable recording medium having embodied thereon a computer program for a method for intra prediction of video data. The method includes performing intra prediction on a current macroblock in a plurality of 16×16 intra prediction modes using original pixel values of a plurality of previous macroblocks that are adjacent to the current macroblock and determining one 16×16 intra prediction mode having the smallest intra prediction error among the plurality of 16×16 intra prediction modes, performing intra prediction on the current macroblock in a plurality of 4×4 intra prediction modes using the original pixel values of the plurality of previous macroblocks and determining one 4×4 intra prediction mode having the smallest intra prediction error among the plurality of 4×4 intra prediction modes, and determining which one of the determined 16×16 intra prediction mode and the determined 4×4 intra prediction mode has the smaller intra prediction error and using the intra prediction mode having the smaller area as an optimum intra prediction mode for the current macroblock.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 shows previous data units used in a conventional intra prediction method for predicting a current data unit;

FIG. 2 shows pixels of previous data units used for conventional intra prediction;

FIG. 3A shows a vertical mode prescribed in conventional MPEG-4 AVC;

FIG. 3B shows a horizontal mode prescribed in conventional MPEG-4 AVC;

FIG. 3C shows a DC mode prescribed in conventional MPEG-4 AVC;

FIG. 3D shows a plane mode prescribed in conventional MPEG-4 AVC;

FIG. 4 is a flowchart illustrating a method for intra prediction of video data according to an embodiment of the present invention;

FIG. 5 is a flowchart illustrating a method for obtaining a cost_{—}16×16_error term;

FIG. 6 is a flowchart illustrating a method for obtaining a cost_{—}4×4_error term;

FIG. 7 is a view for explaining intra prediction that is performed in 4×4 subblock units in operations S310 and S330; and

FIG. 8 is a block diagram of an apparatus for intra prediction of video data according to the embodiment of the present invention.

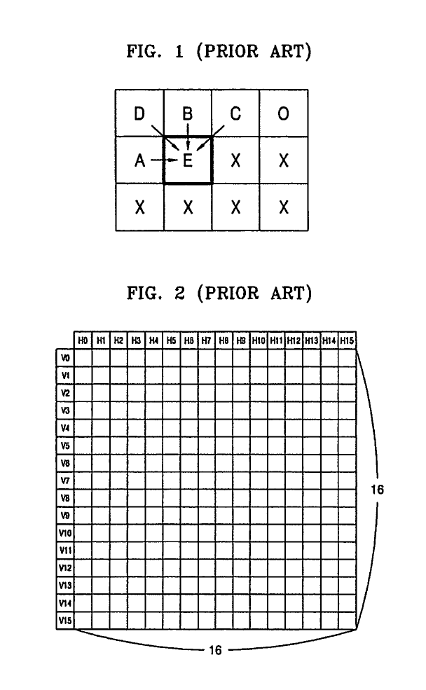

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

FIG. 4 is a flowchart illustrating a method for intra prediction of video data according to an embodiment of the present invention.

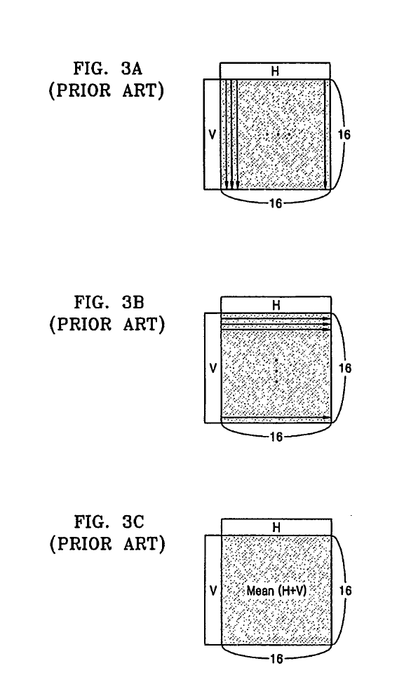

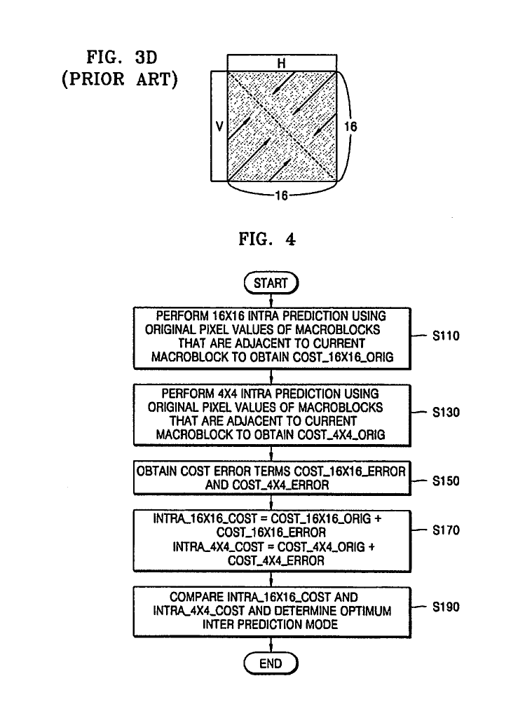

In operation S110, 16×16 intra prediction is performed using original (i.e., not reconstructed) pixel values of macroblocks that are adjacent to a current macroblock, one having the best prediction result is selected from a plurality of 16×16 intra prediction modes, and a cost function value cost_{—}16×16_orig according to the selected mode, is obtained. A 16×16 intra prediction may be performed in a manner as defined in the conventional H.264 standard. In other words, pixel values of the adjacent macroblocks shown in FIG. 2 are used, and in H.264, reconstructed pixel values are used. On the other hand, in this embodiment, original pixel values are used. Intra prediction is performed in each of four 16×16 intra prediction modes shown in FIGS. 3A through 3D and a cost function value according to each prediction mode is calculated. It is understood that the 16×16 intra prediction mode alternatively can be a 32×32 intra prediction mode or a K×L intra prediction mode. It is also understand that it can be K=L or K≠L.

The cost function indicates the accuracy of predictive encoding and the number of generated bits. Cost functions that can be used for predictive encoding include a sum of absolute difference (SAD) cost function, a sum of absolute transformed difference (SATD) cost function, a sum of square difference (SSD) cost function, a mean of absolute difference (MAD) cost function, and a Lagrange cost function. For example, when the SAD is used as the cost function, P[x, y] is an actual pixel value of the current data unit that is not yet encoded, and P′[x, y] is a predicted pixel value of the current data unit, the cost function is defined as follows.
SAD=Sum_{x=0 . . . 15, y=0 . . . 15}|P[x, y]−P′[x, y]| (1)

A cost function value is calculated based on a result of intra prediction that is performed in each of the four 16×1 6 intra prediction modes, a mode having the smallest cost function value among four cost function values is determined to be the best 16×16 intra prediction mode for the current macroblock, and a cost function value cost_{—}16×16_orig according to the determined mode, is obtained.

In operation S130, 4×4 intra prediction is performed using original sample values of macroblocks that are adjacent to a current macroblock, one having the best prediction result is selected from nine 4×4 intra prediction modes, and a cost function value cost_{—}4×4_orig according to the selected mode, is obtained. 4×4 intra prediction may be performed in a manner as defined in the conventional H.264 standard. Reconstructed pixel values are used in H.264, but original pixel values are used in this embodiment. It is understood that the 4×4 intra prediction mode alternatively can be an M×N intra prediction mode. It is also understood that it can be M=N or M≠N.

Since 4×4 intra prediction is performed in 4×4 subblock units, the current macroblock is divided into sixteen 4×4 subblocks, intra prediction is performed in each of nine 4×4 intra prediction modes for each of the 4×4 subblocks, and a cost function value according to each mode is calculated. A mode having the smallest cost function value among 9 cost function values obtained for each 4×4 subblock is determined as the best 4×4 intra prediction mode for each 4×4 subblock.

Thus, according to this embodiment, one 4×4 intra prediction mode and one cost function value are determined for each 4×4 subblock. A cost function value cost_{—}4×4_orig that indicates the accuracy of 4×4 intra prediction for the current macroblock is obtained by summing all the cost function values obtained for all the 4×4 subblocks.

Since intra prediction is performed using original values of pixels that are adjacent to the current macroblock in the present invention, cost_{—}16×16_orig obtained in operation S110 and cost_{—}4×4_orig obtained in operation S130 are different from those obtained when reconstructed values of the adjacent pixels are used. In other words, since intra prediction is performed using the original values of the adjacent pixels, an intra prediction error may occur.

In operation S150, to compensate for such an intra prediction error, cost error terms cost_{—}16×16_orig and cost_{—}4×4_orig, i.e., cost_{—}16×16_error and cost_{—}4×4_error, are obtained.

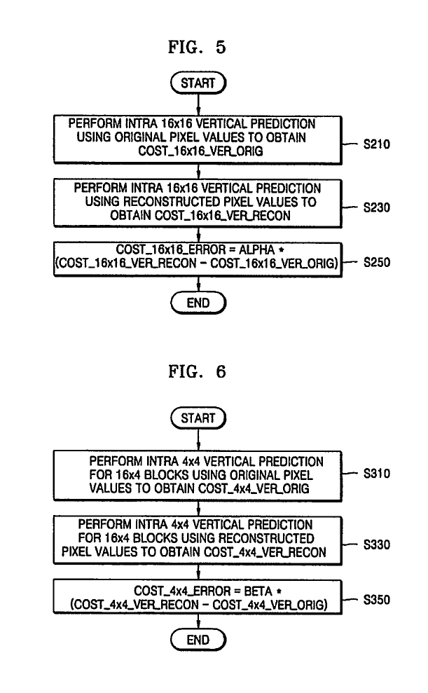

FIG. 5 is a flowchart illustrating a method for obtaining the cost_{—}16×16_error term.

In general, cost_{—}16×16_error is obtained as follows; using the fact that a previous macroblock located above a current macroblock has always been reconstructed when an intra prediction on the current macroblock is performed.

In operation S210, intra vertical prediction is performed on a current macroblock in a vertical prediction mode as shown in FIG. 3A, using original values of pixels at the bottom of the previous macroblock located above the current macroblock, and a cost function value cost_{—}16×16_ver_orig according to the vertical prediction mode, is obtained.

In operation S230, intra vertical prediction is performed on the current macroblock in the vertical prediction mode using reconstructed values of the pixels at the bottom of the previous macroblock located above the current macroblock, and a cost function value cost_{—}16×16_ver_recon according to the vertical prediction mode, is obtained.

In operation S250, cost_{—}16×16_error is obtained as follows.
cost_{—}16×16_{—}error=α*(cost_{—}16×16_{—}ver_{—}recon−cost_{—}16×16_{—}ver_{—}orig) (2),
where α is experimentally determined.

FIG. 6 is a flowchart illustrating a method for obtaining the cost_{—}4×4_error term.

In the same manner as when cost_{—}16×16_error is obtained, cost_{—}4×4_error is obtained by performing intra vertical prediction using the original and reconstructed values of the pixels at the bottom of the previous macroblock located above the current macroblock.

In operation S310, intra vertical prediction is performed on 4 top-most 4×4 subblocks among sixteen 4×4 subblocks that are included in the current macroblock, using the original values of the pixels at the bottom of the previous macroblock located above the current macroblock, and a cost function value cost_{—}4×4_ver_orig is obtained.

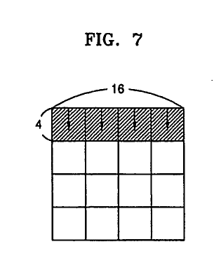

In operations S310 and S330, a reason why intra vertical prediction is not performed on all the 16 4×4 subblocks included in the current macroblock, but on the 4 top-most 4×4 subblocks will be described. FIG. 7 is a view for explaining intra prediction that is performed in 4×4 subblock units in operations S310 and S330. A macroblock shown in FIG. 7 is a current macroblock and FIG. 7 shows prediction for four top-most 4×4 subblocks among sixteen 4×4 subblocks included in the current macroblock. In operation S310, intra vertical prediction is performed using original values of pixels at the bottom of a previous macroblock located above the current macroblock, and in operation S330, intra vertical prediction is performed using reconstructed values of the pixels at the bottom of the previous macroblock located above the current macroblock.

Since intra vertical prediction is performed in 4×4 subblock units using the reconstructed pixel values in step S330, reproduced pixel values of 4×4 subblocks should be used when intra vertical prediction is performed on 4×4 subblocks that are located below the top-most line of the current macroblock shown in FIG. 7. For example, to perform intra vertical prediction for four 4×4 subblocks included in the line second from the top of the current macroblock, reconstructed values of pixels at the bottom of the four 4×4 subblocks in the top-most line of the current macroblock should be used. According to the present invention, since reconstructed values of pixels of a current macroblock are not yet obtained at the time of intra prediction of the current macroblock, operation S330 cannot be performed on all the 4×4 subblocks included in the current macroblock. Thus, intra prediction is only performed on the 4 top-most 4×4 subblocks of the current macroblock.

After operations S310 and S330, cost_{—}4×4_error is obtained as follows in operation S350.
cost_{—}4×4_{—}error=β*(cost_{—}4×4_{—}ver_{—}recon−cost_{—}4×4_{—}ver_{—}orig) (3),
where β is experimentally determined. However, since cost_{—}4×4_ver_recon and cost_{—}4×4_ver_orig are products of performing 4×4 intra prediction only on the 4 top-most 4×4 subblocks of the current macroblock instead of all the 4×4 subblocks of the current macroblock, β is set larger than α.

In other words, referring to FIG. 4, after cost_{—}16×16_error and cost_{—}4×4_error are obtained in operation S150, a 16×16 intra prediction cost function value intra_{—}16×16_cost, whose error is compensated for by adding cost_{—}16×16_orig and cost_{—}16×16_error, and an 4×4 intra prediction cost function value intra_{—}4×4_cost, whose error is compensated for by adding cost_{—}4×4_orig and cost_{—}4×4_error, are obtained in operation S170.

In operation S190, intra_{—}16×16_cost and intra_{—}4×4_cost that are obtained in operation S170 are compared with each other and a mode having the smaller cost function value is determined to be an optimum intra prediction mode for the current macroblock.

Alternatively, if operations S150 and S170 are not performed, the cost function value cost_{—}16×16_orig that is obtained as a product of 16×16 intra prediction in operation S110 and the cost function value cost_{—}4×4_orig that is obtained as a product of 4×4 intra prediction in operation S130 are compared, and a mode having the smaller cost function value is determined to be an optimum intra prediction mode. However, for more accurate intra prediction, it is desirable to perform operations S150 and S170, which are intended to compensate for an error caused by intra prediction using the original values of the pixels that are adjacent to the current macroblock.

Although not shown in the drawings, an optimum intra prediction mode for the current macroblock may be determined by comparing three values, i.e., intra_{—}16×16_cost and intra_{—}4×4_cost that are obtained in operation S170 and a cost function value that is obtained as a product of inter prediction, i.e., motion estimation.

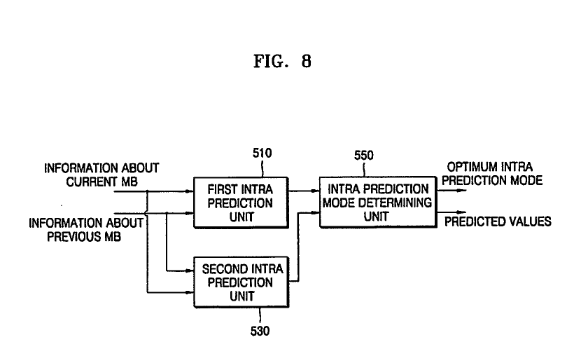

FIG. 8 is a block diagram of an apparatus for intra prediction of video data according to an embodiment of the present invention. Referring to FIG. 8, the apparatus for intra prediction of video data includes a first intra prediction unit 510, a second intra prediction unit 530, and an intra prediction mode determining unit 550.

The apparatus for intra prediction of video data shown in FIG. 8 performs the method for intra prediction of video data according to the embodiment of the present invention that is described above with reference to FIGS. 4 through 7.

The first intra prediction unit 510 performs intra prediction on a current macroblock using original pixel values of a plurality of previous macroblocks that are adjacent to the current macroblock in a plurality of 16×16 intra prediction modes, determines one 16×16 intra prediction mode having the smallest intra prediction error among the plurality of 16×16 intra prediction modes, and outputs the determined 16×16 intra prediction mode to the intra prediction mode determining unit 550.

The second intra prediction unit 530 performs intra prediction on the current macroblock using the original pixel values of the plurality of previous macroblocks in a plurality of 4×4 intra prediction modes, determines one 4×4 intra prediction mode having the smallest intra prediction error among the plurality of 4×4 intra prediction modes, and outputs the determined 4×4 intra prediction mode to the intra prediction mode determining unit 550.

The intra prediction mode determining unit 550 determines one of the 16×16 intra prediction mode received from the first intra prediction unit 510 and the 4×4 intra prediction mode received from the second intra prediction unit 530 having the smaller intra prediction error as an optimum intra prediction mode for the current macroblock.

Also, the intra prediction mode determining unit 550 determines the optimum intra prediction mode based on the intra prediction error caused by 16×16 intra prediction and 4×4 intra prediction using the original pixel values of the plurality of previous macroblocks. To this end, the first intra prediction unit 510 obtains cost_{—}16×16_orig, which indicates the accuracy of intra prediction in the determined 16×16 intra prediction mode, and cost_{—}16×16_error, which is a cost function value error caused by 16×16 intra prediction, and outputs them to the intra prediction mode determining unit 550. The second intra prediction unit 530 obtains cost_{—}4×4_orig, which indicates the accuracy of intra prediction in the determined 4×4 intra prediction mode, and cost_{—}4×4_error, which is a cost function value error caused by 4×4 intra prediction, and outputs them to the intra prediction mode determining unit 550. The intra prediction mode determining unit 550 adds the values cost_{—}16×16_orig and cost_{—}16×16_error to obtain a cost function value intra_{—}16×16_cost of error-compensated 16×16 intra prediction, adds cost_{—}4×4_orig and cost_{—}4×4_error to obtain a cost function value intra_{—}4×4_cost of error-compensated 4×4 intra prediction, compares intra_{—}16×16_cost and intra_{—}4×4_cost, and determines an optimum intra prediction mode for the current macroblock.

The first intra prediction unit 510 performs 16×16 vertical prediction using original pixel values of a previous macroblock located above the current macroblock to obtain a cost function value cost_{—}16×16_ver_orig of 16×16 vertical prediction, performs 16×16 vertical prediction using reconstructed pixel values of the previous macroblock located above the current macroblock to obtain a cost function value cost_{—}16×16_ver_recon of 16×16 vertical prediction, and determines cost_{—}16×16_error using a difference between cost_{—}16×16_ver_orig and cost_{—}16×16_ver_recon.

Also, the second intra prediction unit 530 performs 4×4 vertical prediction using original pixel values of the bottom-most four blocks of 4×4 of the previous macroblock located above the current macroblock to obtain a cost function value cost_{—}4×4_ver_orig of 4×4 vertical prediction, performs 4×4 vertical prediction using reconstructed pixel values of the four bottom-most 4×4 blocks of the previous macroblock located above the current macroblock to obtain a cost function value cost_{—}4×4_ver_recon of 4×4 vertical prediction, and determines cost_{—}4×4_error based on a difference between cost_{—}4×4_ver_orig and cost_{—}4×4_ver_recon.

As described above, according to the present invention, at the time of intra prediction, it is possible to reduce the complexity of intra prediction by performing intra prediction using original values of pixels that are adjacent to a current macroblock and compensating for an error caused by intra prediction. Also, by reducing the complexity of intra prediction, faster and simpler intra prediction can be obtained.

Meanwhile, the present invention can also be embodied as a computer-readable code on a computer-readable recording medium. The computer-readable recording medium is any data storage device that can store data, which can be thereafter read by a computer system. Examples of the computer-readable recording medium include read-only memory (ROM), random-access memory (RAM), CD-ROMs, magnetic tapes, floppy disks, optical data storage devices, and carrier waves. The computer-readable recording medium can also be distributed over network coupled computer systems so that the computer-readable code is stored and executed in a distributed fashion.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method for intra prediction of video data, comprising:
performing intra prediction on a current macroblock in a plurality of K×L intra prediction modes using original pixel values of a plurality of previous macroblocks that are adjacent to the current macroblock and determining one K×L intra prediction mode having the smallest or relatively low intra prediction error among the plurality of K×L intra prediction modes;
performing intra prediction on the current macroblock in a plurality of M×N intra prediction modes using the original pixel values of the plurality of previous macroblocks and determining one M×N intra prediction mode having the smallest or a relatively low intra prediction error among the plurality of M×N intra prediction modes; and
determining which one of the determined K×L intra prediction mode and the determined M×N intra prediction mode has the smaller intra prediction error and using the intra prediction mode having the smaller error as an optimum intra prediction mode for the current macroblock.

2. The method of claim 1, wherein the K and L are 16 and the M and N are 4.

3. The method of claim 1, wherein K=L.

4. The method of claim 1, wherein M=N.

5. The method of claim 1, wherein in the determining of the optimum intra prediction mode, the optimum intra prediction mode is determined based on intra prediction errors caused by K×L intra prediction and M×N intra prediction using the original pixel values of the plurality of previous macroblocks.

6. The method of claim 1, further comprising:
obtaining a cost function value cost_K×L_orig that indicates the accuracy of intra prediction in the determined 16×16 intra prediction mode;
obtaining a cost function value cost_M×N_orig that indicates the accuracy of intra prediction in the determined 4×4 intra prediction mode;
obtaining a cost function value error cost_K×L_error of K×L intra prediction;
obtaining a cost function value error cost_M×N_error of M×N intra prediction;
obtaining a cost function value intra_K×L_cost of error-compensated K×L intra prediction by adding the cost function value cost_K×L_orig and the cost function value error cost_K×L_error and obtaining a cost function value intra_M×N_cost of error-compensated M×N intra prediction by adding the cost function value cost_M×N_orig and the cost function value error cost_M×N_error; and
determining the optimum intra prediction mode by comparing the cost function values intra_K×L_cost and intra_M×N_cost.

7. The method of claim 6, wherein the obtaining of the cost function value error cost_K×L_error comprises:
performing K×L vertical prediction using original pixel values of a previous macroblock located above the current macroblock to obtain a cost function value cost_K×L_ver_orig of K×L vertical prediction;
performing K×L vertical prediction using reconstructed pixel values of the previous macroblock located above the current macroblock to obtain a cost function value cost_K×L_ver_recon of K×L vertical prediction; and
determining the cost function value error cost_K×L_error using a difference between the cost function values cost_K×L_ver_orig and cost_K×L_ver_recon.

8. The method of claim 6, wherein the obtaining of the cost function value error cost_M×N_error comprises:
performing M×N vertical prediction using original pixel values of bottom-most 4 blocks of M×N of the previous macroblock located above the current macroblock to obtain a cost function value cost_M×N ver_orig of M×N vertical prediction;
performing M×N vertical prediction using reconstructed pixel values of the bottom-most 4 blocks of M×N to obtain a cost function value cost_M×N_ver_recon of M×N vertical prediction; and
determining the cost function value error cost_M×N_error using a between the cost function values cost_M×N_ver_orig and cost_M×N_ver_recon.

9. The method of claim 6, wherein the K and L are 16 and the M and N are 4.

10. The method of claim 1, wherein K=L.

11. The method of claim 1, wherein the M=N.

12. An apparatus for intra prediction of video data, the apparatus comprising:
a first intra prediction unit performing intra prediction on a current macroblock in a plurality of K×L intra prediction modes using original pixel values of a plurality of previous macroblocks that are adjacent to the current macroblock and determining one K×L intra prediction mode having the smallest intra prediction error or a relatively low intra prediction error among the plurality of K×L intra prediction modes;
a second intra prediction unit performing intra prediction on the current macroblock in a plurality of M×N intra prediction modes using the original pixel values of the plurality of previous macroblocks and determining one M×N intra prediction mode having the smallest or relatively low intra prediction error among the plurality of M×N intra prediction modes; and
an intra prediction mode determining unit determining which one of the determined K×L intra prediction mode and the determined M×N intra prediction mode has the smaller intra prediction error and using the intra prediction mode having the smaller error as an optimum intra prediction mode for the current macroblock.

13. The apparatus of claim 12, wherein the K and L are 16 and the M and N are 4.

14. The method of claim 1, wherein K=L.

15. The method of claim 1, wherein M=N.

16. The apparatus of claim 12, wherein the intra prediction mode determining unit determines the optimum intra prediction mode based on intra prediction errors caused by K×L intra prediction and M×N intra prediction using the original pixel values of the plurality of previous macroblocks.

18. The apparatus of claim 12 wherein the first intra prediction unit outputs a cost function value cost_K×L_orig that indicates the accuracy of intra prediction in the determined K×L intra prediction mode and a cost function value error cost_K×L_error of K×L intra prediction to the intra prediction mode determining unit; the second intra prediction unit outputs a cost function value cost_M×N_orig that indicates the accuracy of intra prediction in the determined M×N intra prediction mode and a cost function value error cost_M×N_error of M×N intra prediction; and
the intra prediction mode determining unit obtains a cost function value intra_K×L_cost of error-compensated K×L intra prediction by adding the cost function value cost_K×L_orig and the cost function value error cost_K×L_error, obtains a cost function value intra_M×N_cost of error-compensated M×N intra prediction by adding the cost function value cost_M×N_orig and the cost function value error cost_M×N_error, and determines the optimum intra prediction mode by comparing the cost function values intra_K×L_cost and intra_M×N_cost.

19. The apparatus of claim 18, wherein the first intra prediction unit performs K×L vertical prediction using original pixel values of a previous macroblock located above the current macroblock to obtain a cost function value cost_K×L_ver_orig of K×L vertical prediction, performs K×L vertical prediction using reconstructed pixel values of the previous macroblock located above the current macroblock to obtain a cost function value cost_K×L_ver_recon of K×L vertical prediction, and determines the cost function value error cost_K×L_error using a difference between the cost function values cost_K×L_ver_orig and cost_K×L_ver_recon.

20. The apparatus of claim 18, wherein the second intra prediction unit performs M×N vertical prediction using original pixel values of bottom-most 4 M×N blocks of the previous macroblock located above the current macroblock to obtain a cost function value cost_M×N_ver_orig of M×N vertical prediction, performs M×N vertical prediction using reconstructed pixel values of the bottom-most 4 M×N blocks to obtain a cost function value cost_M×N_ver_recon of M×N vertical prediction, and determines the cost function value error cost_M×N_error between the cost function values cost_M×N_ver_orig and cost_M×N_ver_recon.

21. The apparatus of claim 18, wherein the K and L are 16 and the M and N are 4.

22. The apparatus of claim 18, wherein K=L.

23. The apparatus of claim 18, wherein M=N.

24. A computer-readable recording medium having embodied thereon a computer program controlling a computer to perform a method for intra prediction of video data, the method comprising:
performing intra prediction on a current macroblock in a plurality of K×L intra prediction modes using original pixel values of a plurality of previous macroblocks that are adjacent to the current macroblock and determining one K×L intra prediction mode having the smallest or a relatively low intra prediction error among the plurality of K×L intra prediction modes;
performing intra prediction on the current macroblock in a plurality of M×N intra prediction modes using the original pixel values of the plurality of previous macroblocks and determining one M×N intra prediction mode having the smallest or a relatively low intra prediction error among the plurality of M×N intra prediction modes; and
determining which one of the determined K×L intra prediction mode and the determined M×N intra prediction mode has the smaller intra prediction error and using the intra prediction mode having the smaller error as an optimum intra prediction mode for the current macroblock.

25. The computer-readable recording medium of claim 24, wherein in the determining of the optimum intra prediction mode, the optimum intra prediction mode is determined based on intra prediction errors caused by K×L intra prediction and M×N intra prediction using the original pixel values of the plurality of previous macroblocks.

26. The computer-readable recording medium of claim 24, wherein the method further comprises:
obtaining a cost function value cost_K×L_orig that indicates the accuracy of intra prediction in the determined K×L intra prediction mode;
obtaining a cost function value cost_M×N_orig that indicates the accuracy of intra prediction in the determined 4×4 intra prediction mode;
obtaining a cost function value error cost_K×L_error of K×L intra prediction;
obtaining a cost function value error cost_M×N_error of M×N intra prediction;
obtaining a cost function value intra_K×L_cost of error-compensated K×L intra prediction by adding the cost function value cost_K×L_orig and the cost function value error cost_K×L_error and obtaining a cost function value intra_M×N_cost of error-compensated M×N intra prediction by adding the cost function value cost_M×N_orig and the cost function value error cost_M×N_error; and
determining the optimum intra prediction mode by comparing the cost function values intra_K×L_cost and intra_M×N_cost.

27. The computer-readable recording medium of claim 24, wherein the obtaining of the cost function value error cost_K×L_error comprises:
performing K×L vertical prediction using original pixel values of a previous macroblock located above the current macroblock to obtain a cost function value cost_K×L_ver_orig of K×L vertical prediction;
performing K×L vertical prediction using reconstructed pixel values of the previous macroblock located above the current macroblock to obtain a cost function value cost_K×L_ver_recon of K×L vertical prediction; and
determining the cost function value error cost_K×L_error using a difference between the cost function values cost_K×L_ver_orig and cost_K×L_ver_recon.

28. The computer-readable recording medium of claim 24, wherein the obtaining of the cost function value error cost_M×N_error comprises:
performing M×N vertical prediction using original pixel values of bottom-most 4 blocks of M×N of the previous macroblock located above the current macroblock to obtain a cost function value cost_M×N ver_orig of M×N vertical prediction;
performing 4×4 vertical prediction using reconstructed pixel values of the bottom-most 4 blocks of M×N to obtain a cost function value cost_M×N_ver_recon of M×N vertical prediction; and
determining the cost function value error cost_M×N_error using a between the cost function values cost_M×N_ver_orig and cost_M×N_ver_recon.

29. A method for intra prediction of video data, comprising:
performing intra prediction on a current macroblock in a plurality of high intra prediction modes using original pixel values of a plurality of previous macroblocks that are adjacent to the current macroblock and determining one high intra prediction mode having a relatively low intra prediction error among the plurality of large intra prediction modes;
performing intra prediction on the current macroblock in a plurality of low intra prediction modes using the original pixel values of the plurality of previous macroblocks and determining one small intra prediction mode having the smallest or a relatively low intra prediction error among the plurality of small intra prediction modes; and
determining which one of the determined large intra prediction mode and the determined small intra prediction mode has the smaller intra prediction error and using the intra prediction mode having the smaller prediction error as an optimum intra prediction mode for the current macroblock.
